(19) United States
(12) Patent Application Publication
(10) Pub. No.: US 2025/0069800 A1
(43) Pub. Date: Feb. 27, 2025

(54) Radio-Frequency Transformer with Switchable Capacitor Array

(71) Applicant: Apple Inc., Cupertino, CA (US)

(72) Inventors: Haowei Jiang, San Diego, CA (US); Ming-Da Tsai, San Jose, CA (US); Frederic Bossu, Carlsbad, CA (US)

(21) Appl. No.: 18/454,708

(22) Filed: Aug. 23, 2023

(51) Int. Cl. H01F 27/40; H01F 17/00; H01F 17/02

(52) U.S. Cl. CPC H01F 27/40; H01F 17/0006; H01F 17/02

(57) ABSTRACT

An electronic device may include wireless circuitry having an on-chip transformer. The transformer may convey a radio-frequency signal and may include a primary coil and a secondary coil. The primary coil may have a center tap. A distributed capacitor array (DCA) may be coupled to the primary coil around the center tap. The DCA may include switchable capacitors coupled in parallel between ground and points on the primary coil on either side of the center tap. When active, each switchable capacitor contributes a different weighting to the operation of the transformer based on its distance from the center tap. A set of one or more of the switchable capacitors may be activated to contribute an asymmetric weighting to the operation of the transformer that mitigates process-related asymmetry in the transformer. This may serve to mitigate undesired common mode to direct mode signal conversion by the transformer.

### FIELD

This disclosure relates generally to electronic devices, including electronic devices with wireless communications circuitry.

### BACKGROUND

Electronic devices can be provided with wireless communications capabilities. An electronic device with wireless communications capabilities has wireless communications circuitry with one or more antennas. The wireless communications circuitry uses the antennas to receive and transmit radio-frequency signals.

The wireless communications circuitry can include a transformer that is used in conveying the radio-frequency signals. If care is not taken, transformer imbalance can cause the wireless communications circuitry to exhibit suboptimal levels of performance.

### SUMMARY

An electronic device may include wireless circuitry. The wireless circuitry may include an input stage and an output stage. The input stage may include a mixer and the output stage may include an amplifier, as one example. The wireless circuitry may include a transformer coupled between the input stage and the output stage. The transformer may be an on-chip transformer disposed on a substrate. The transformer may convey a radio-frequency signal from the input stage to the output stage. The transformer may include a primary coil coupled to the input stage and a secondary coil coupled to the output stage.

The primary coil may have a center tap. The transformer may include a distributed capacitor array (DCA) coupled to the primary coil around the center tap. The DCA may include a first set of switchable capacitors coupled in parallel between a first set of points on the primary coil and ground. The first set of points may be located between the center tap and a first terminal of the primary coil. The DCA may include a second set of switchable capacitors coupled in parallel between a second set of points on the primary coil and ground. The second set of points may be located between the center tap and a second terminal of the primary coil.

When active, each switchable capacitor contributes a different weighting to the operation of the transformer based on its distance from the center tap. A set of one or more of the switchable capacitors may be activated to contribute an asymmetric weighting to the operation of the transformer that mitigates process-related asymmetry in the transformer. This may serve to mitigate undesired common mode to direct mode signal conversion by the transformer without affecting the direct mode of the signal, thereby minimizing emissions violations and other performance issues at the output stage.

An aspect of the disclosure provides a transformer. The transformer can include a first coil extending from a first terminal to a second terminal, the first coil having a center tap. The transformer can include a second coil extending from a third terminal to a fourth terminal, the second coil being magnetically coupled to the first coil. The transformer can include a first capacitor coupled between a reference potential and a first point on the first coil, the first point being between the center tap and the first terminal.

An aspect of the disclosure provides a radio-frequency transceiver. The radio-frequency transceiver can include an input stage. The radio-frequency transceiver can include an output stage. The radio-frequency transceiver can include a transformer coupled between the input stage and the output stage. The transformer can include a first coil coupled to the input stage and having a center tap. The transformer can include a second coil coupled to the output stage, the second coil being magnetically coupled to the first coil. The capacitor array can be coupled to the first coil around the center tap.

An aspect of the disclosure provides an electronic device. The electronic device can include a substrate. The electronic device can include an input path having a first signal line on the substrate and a second signal line on the substrate. The electronic device can include an output path having a third signal line on the substrate. The electronic device can include a transformer on the substrate. The transformer can include a first coil having a first terminal coupled to the first signal line, a second terminal coupled to the second signal line, and a center tap contact. The transformer can include a second coil having a third terminal coupled to the third signal line. The electronic device can include a set of capacitors coupled in parallel between a set of points on the first coil and a reference potential, the set of points being between the center tap contact and the first terminal.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having transceiver circuitry and front-end circuitry in accordance with some embodiments.

FIG. 3 is a block diagram of illustrative wireless circuitry having a transformer in accordance with some embodiments.

FIG. 4 is a circuit diagram of an illustrative transformer having a distributed capacitor array that mitigates transformer imbalance in accordance with some embodiments.

FIG. 5 is a layout diagram of an illustrative transformer having a distributed capacitor array that mitigates transformer imbalance in accordance with some embodiments.

FIG. 6 is a flow chart of illustrative operations involved in adjusting a distributed capacitor array to mitigate transformer imbalance in accordance with some embodiments.

### DETAILED DESCRIPTION

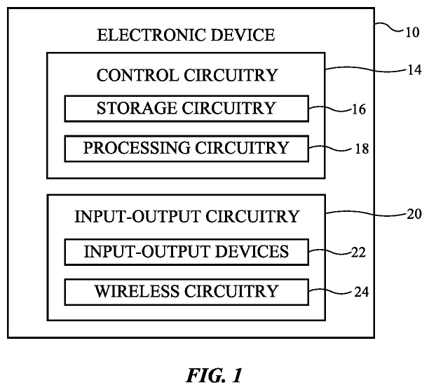

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, radio-frequency front end circuitry, and/or any other circuitry for transmitting and/or receiving radio-frequency signals using the antenna(s).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 1000 GHz (e.g., 6G bands), near-field communications (NFC) frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

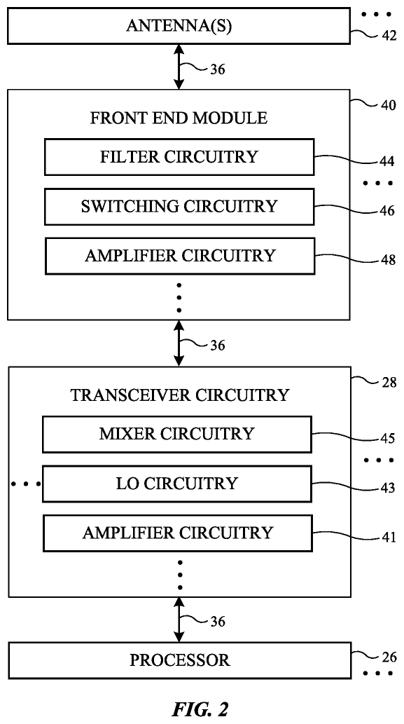

FIG. 2 is a diagram showing illustrative components within wireless circuitry 24. As shown in FIG. 2, wireless circuitry 24 may include one or more processors such as processor(s) 26, radio-frequency (RF) transceiver circuitry such as radio-frequency transceiver 28, radio-frequency front end circuitry such as radio-frequency front end module (FEM) 40, and antenna(s) 42. Processor 26 may include baseband circuitry (e.g., one or more baseband processors), an application processor, a digital signal processor, a microcontroller, a microprocessor, a central processing unit (CPU), a programmable device, an a combination of these circuits, and/or one or more processors within processing circuitry 18 of FIG. 1. Processor 26 may be configured to generate digital (transmit or baseband) signals. Processor 26 may be coupled to transceiver 28 over path 34 (sometimes referred to as a baseband path). Transceiver 28 may be coupled to antenna 42 via radio-frequency transmission line path 36. If desired, one or more radio-frequency front end modules such as radio-frequency front end module 40 may be disposed along radio-frequency transmission line path 36 between transceiver 28 and antenna 42.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna (IFA) structures, slot antenna structures, planar inverted-F antenna (PIFA) structures, helical antenna structures, monopole antennas, dipoles, dielectric resonator antenna (DRA) structures, waveguide antenna structures, bowtie antenna structures, hybrids of these designs, etc. If desired, two or more antennas 42 may be arranged into one or more phased antenna arrays (e.g., for conveying radio-frequency signals at millimeter wave frequencies). If desired, parasitic elements may be included in antenna 42 to adjust antenna performance. If desired, antenna 42 may be provided with a conductive cavity that backs the antenna resonating element of antenna 42 (e.g., antenna 42 may be a cavity-backed antenna such as a cavity-backed slot antenna).

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 28, any desired number of front end modules 40, and any desired number of antennas 42. Each processor 26 may be coupled to one or more transceiver 28 over respective paths 34. Each transceiver 28 may include a transmitter circuit configured to output uplink signals to antenna 42, may include a receiver circuit configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Front end module (FEM) 40 may include radio-frequency front end circuitry that operates on the radio-frequency signals conveyed (transmitted and/or received) over radio-frequency transmission line path 36. Front end module may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and one or more low-noise amplifiers), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards. In one suitable implementation, radio-frequency transmission line paths such as radio-frequency transmission line path 36 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Transceiver 28 may include wireless local area network transceiver circuitry that handles WLAN communications bands (e.g., Wi-Fi® (IEEE 802.11) or other WLAN communications bands) such as a 2.4 GHZ WLAN band (e.g., from 2400 to 2480 MHZ), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network transceiver circuitry that handles the 2.4 GHZ Bluetooth® band or other WPAN communications bands, cellular telephone transceiver circuitry that handles cellular telephone bands (e.g., bands from about 600 MHz to about 5 GHZ, 3G bands, 4G LTE bands, 5G New Radio Frequency Range 1 (FR1) bands below 10 GHZ, 5G New Radio Frequency Range 2 (FR2) bands between 20 and 60 GHZ, 6G bands above 100 GHz, etc.), near-field communications (NFC) transceiver circuitry that handles near-field communications bands (e.g., at 13.56 MHZ), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

The term “convey radio-frequency signals” as used herein means the transmission and/or reception of the radio-frequency signals (e.g., for performing unidirectional and/or bidirectional wireless communications with external wireless communications equipment). In performing wireless transmission, processor 26 may provide digital signals to transceiver 28 over path 34. Transceiver 28 may further include circuitry for converting the baseband signals received from processor 26 into corresponding intermediate frequency or radio-frequency signals. For example, transceiver 28 may include mixer circuitry 45 that up-converts (or modulates) the baseband signals to intermediate frequencies (e.g., as intermediate frequency (IF) signals), that up-converts the baseband signals to radio frequencies higher than the intermediate frequencies (e.g., as radio-frequency (RF) signals), and/or that up-converts IF signals to radio frequencies prior to transmission over antenna 42. Transceiver 28 may also include digital-to-analog converter (DAC) and/or analog-to-digital converter (ADC) circuitry that converts signals between digital and analog domains. Transceiver 28 may include amplifier circuitry 41 (e.g., one or more power amplifiers) that amplify the radio-frequency signals for transmission. Additionally or alternatively, one or more power amplifiers in amplifier circuitry 48 may amplify the radio-frequency signals for transmission. Transceiver 28 may include a transmitter that transmits the radio-frequency signals over antenna 42 via radio-frequency transmission line path 36 and front end module 40. Antenna 42 may transmit the radio-frequency signals to external wireless equipment by radiating the radio-frequency signals into free space (or into free space through a dielectric cover layer on device 10).

In performing wireless reception, antenna 42 may receive radio-frequency signals from external wireless equipment (e.g., from free space). The received radio-frequency signals may be conveyed to transceiver 28 via radio-frequency transmission line path 36 and front end module 40. One or more low noise amplifiers in amplifier circuitry 41 and/or amplifier circuitry 48 may amplify the received signals. Transceiver 28 may include circuitry for converting the received radio-frequency signals into corresponding intermediate frequency or baseband signals. For example, transceiver 28 may use mixer circuitry 45 to downconvert (or demodulate) the received radio-frequency signals to intermediate frequencies, to downconvert the received radio-frequency signals to baseband frequencies (e.g., as baseband signals or baseband data), and/or to downconvert IF signals to baseband frequencies prior to conveying the received signals to processor 26 over path 34. Mixer circuitry 45 can include local oscillator circuitry such as local oscillator (LO) circuitry 43. Local oscillator circuitry 43 can generate oscillator signals that mixer circuitry 45 uses to modulate transmit signals from baseband frequencies to radio frequencies and/or to demodulate received signals from radio frequencies to baseband frequencies.

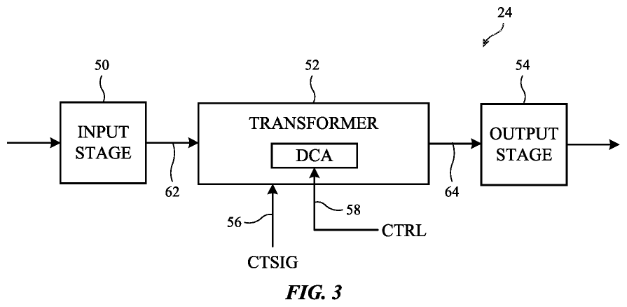

Wireless circuitry 24 may include one or more radio-frequency transformers for use in conveying radio-frequency signals. FIG. 3 is a diagram showing how wireless circuitry 24 may include a transformer for conveying radio-frequency signals. As shown in FIG. 3, wireless circuitry 24 may include a radio-frequency transformer such as transformer 52. Transformer 52 may be disposed on a signal path of wireless circuitry 24 between input circuitry such as input stage 50 and output circuitry such as output stage 54 (e.g., transformer 52 may be coupled between the output of input stage 50 and the input of output stage 54).

Transformer 52 may have an input (e.g., input terminal(s) of a primary coil in the transformer) coupled to input stage 50 over input path 62 (e.g., a differential or single-ended signal path). Transformer 52 may have an output (e.g., output terminal(s) of a secondary coil in the transformer) coupled to output stage 54 over output path 64 (e.g., a differential or single-ended signal path). Input path 62 and output path 64 may form part of radio-frequency transmission line path 36 of FIG. 2, for example.

When wireless circuitry 24 conveys radio-frequency signals, input stage 50 provides the radio-frequency signals to transformer 52 over input path 62. Transformer 52 operates on the radio-frequency signals and passes the radio-frequency signals to output stage 54 over output path 64. Transformer 52 may be disposed in front-end module 40, in transceiver 28, between transceiver 28 and processor 26, or between front-end module 40 and antenna(s) 42 (FIG. 2).

Input stage 50 and output stage 54 may include any desired circuit components (e.g., powered components) in wireless circuitry 24. For example, input stage 50 and/or output stage 54 may include a mixer from mixer circuitry 45 (FIG. 2) (e.g., an upconverter when disposed in a transmitter or transmit path or a downconverter when disposed in a receiver or a receive path of transceiver 28), a portion of a mixer from mixer circuitry 45 (e.g., a transconductor, mixer transistor circuitry such as a switching quad, etc.), an amplifier in amplifier circuitry 41 (e.g., a power amplifier when disposed in a transmitter or transmit path or a low noise amplifier when disposed in a receiver or a receive path of transceiver 28), other circuitry or another component in a transmitter and/or receiver of transceiver 28, a filter from filter circuitry 44, a switch from switching circuitry 46, an amplifier from amplifier circuitry 48 (e.g., a power amplifier when disposed in a transmit path or a low noise amplifier when disposed in a receive path of front-end module 40), other circuitry or another component in front-end module 40, an antenna 42, processor 26, a gain stage (e.g., in amplifier circuitry 48, amplifier circuitry 41, or elsewhere), impedance matching circuitry, antenna tuning circuitry, multiplexer circuitry, and/or any other desired circuitry disposed on the signal path between processor 26 and antenna 42 (FIG. 2). These examples are illustrative and non-limiting. More generally, transformer 52 may be disposed between any two circuits or components in device 10 (e.g., transformer 52 need not be used to convey radio-frequency signals and may instead be used to convey control signals, to distribute power, and/or to convey any other desired signals in device 10). Transformer 52 may perform impedance matching/transformation (e.g., to match an output impedance of input stage 50 to an input impedance of output stage 54) and/or voltage conversion (e.g., step-up or step-down conversion) on the radio-frequency signals conveyed from input stage 50 to output stage 54.

Transformer 52 may include a primary coil magnetically coupled to a secondary coil. The primary coil and/or the secondary coil may include a corresponding center tap. The center tap(s) in transformer 52 may be coupled to one or more center tap paths 56. The center tap(s) may receive center tap signal(s) CTSIG over center tap path(s) 56. Center tap signals CTSIG may include, for example, a power supply voltage (e.g., Vdd), a bias voltage, or another direct current (DC) voltage (e.g., provided by power supply circuitry, the core of a mixer or amplifier in device 10, control circuitry 14 of FIG. 1, etc.). In other implementations, center tap signals CTSIG may include alternating current (AC) signals. In these implementations, one or more fixed (non-switchable) coupling capacitors may be disposed on center tap path(s) 56 if desired. Implementations in which center tap signals CTSIG are DC voltage signals are illustrated herein as an example.

The primary and secondary coil of transformer 52 may be formed from respective conductors (e.g., conductive or metal traces) disposed on one or more layers of a substrate in wireless circuitry 24. The substrate may be an integrated circuit chip substrate or a semiconductor substrate (e.g., a bulk silicon substrate), as examples. In practice, transformers disposed on a substrate (sometimes referred to as on-chip transformers) can exhibit undesirable asymmetry in the primary and/or secondary coils (e.g., due to layout or process variations or asymmetries). When transformer 52 conveys signals, this imbalance can convert common mode (CM) signal components at the primary coil into differential mode (DM) signal components at the secondary winding, where the differential mode components are then passed on to output stage 54. Components in wireless circuitry 24 such as transceiver 28 are generally designed to exhibit relatively high common mode signal rejection (CMR) while enhancing differential mode signals. If care is not taken, this finite CMR arising from asymmetry in transformer 52 can produce undesirable direct mode signal components at output stage 54, which can cause output stage 54 to produce emission violations or otherwise deteriorate the wireless performance of output stage 54.

To mitigate these issues, transformer 52 may include a distributed capacitor array (DCA) 60. DCA 60 is sometimes also referred to herein as switchable capacitor array 60 or simply as capacitor array 60. DCA 60 may include a set of switchable capacitors, each coupled to a different point on one or both coils in transformer 52. Switching circuitry in DCA 60 may receive one or more control signals CTRL over control path 58 that adjust the state of or switch the switchable capacitors. Control signals CTRL may selectively activate or switch on one or more of the switchable capacitors in a manner that causes the capacitance(s) of the activated capacitors to mitigate the asymmetry in transformer 52, thereby minimizing the conversion of CM signal components to DM signal components by transformer 52, thus optimizing the wireless performance of output stage 54 (e.g., by minimizing the amount of DM components converted from CM components that would otherwise cause output stage 54 to produce emissions violations or to otherwise exhibit sub-optimal wireless performance).

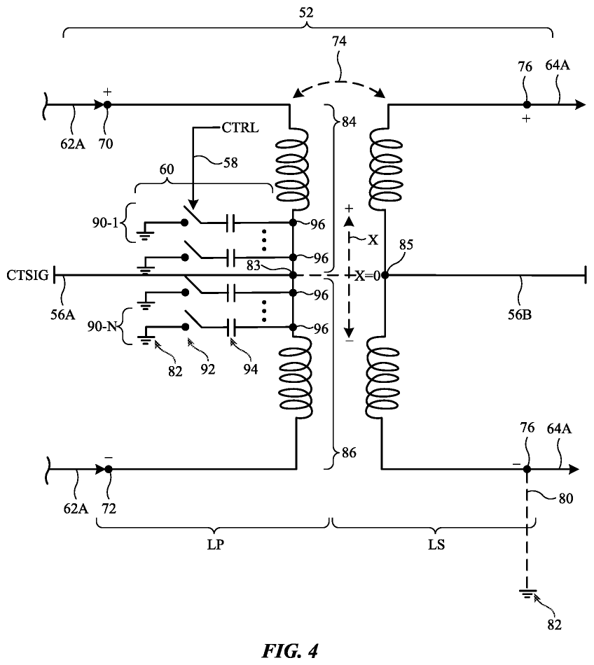

FIG. 4 is a circuit diagram showing how DCA 60 may be integrated into transformer 52 for mitigating asymmetry in transformer 52. As shown in FIG. 4 transformer 52 may include first coil such as primary coil Lp (sometimes referred to herein as first/primary winding Lp or first/primary inductor Lp). Transformer 52 may also include a second coil such as secondary coil Ls (sometimes referred to herein as second/secondary winding Ls or second/secondary inductor Ls).

Primary coil Lp has a first (positive) terminal 70 and an opposing second (negative) terminal 72. Primary coil Lp is formed from a conductor (e.g., one or more conductive traces, conductive windings, conductive vias, and/or other conductive structures on/through one or more layers of the substrate of transformer 52) that is coupled between terminals 70 and 72 (e.g., that extends from terminal 70 to terminal 72).

Input path 62 may be a differential signal path having a first (positive) signal line 62A and a second (negative) signal line 62B. Signal lines 62A and 62B may be a differential pair of signal lines that convey differential radio-frequency signals to transformer 52 (e.g., where the differential signal is provided at an input voltage defined by the delta between a first voltage on signal line 62A and a second voltage on signal line 62B). Terminal 70 of primary coil Lp is coupled to signal line 62A. Terminal 72 of primary coil Lp may be coupled to signal line 62B. Terminals 70 and 72 may collectively form a differential signal (input) port of transformer 52. Terminals 70 and 72 are sometimes also referred to herein as input terminals of transformer 52.

On the other hand, secondary coil Ls has a first (positive) terminal 76 and an opposing second (negative) terminal 78. Secondary coil Ls is formed from a conductor (e.g., one or more conductive traces, conductive windings, conductive vias, and/or other conductive structures on/through one or more layers of the substrate of transformer 52) that is coupled between terminals 76 and 78 (e.g., that extends from terminal 76 to terminal 78).

Output path 64 may be a differential signal path having a first (positive) signal line 64A and a second (negative) signal line 64B. Signal lines 64A and 64B may be a differential pair of signal lines that convey differential radio-frequency signals from transformer 52 to output stage 54. Terminal 76 of secondary coil Ls is coupled to signal line 64A. Terminal 78 of secondary coil Ls may be coupled to signal line 62B. Terminals 76 and 78 may collectively form a differential signal (output) port of transformer 52. Terminals 76 and 78 are sometimes also referred to herein as output terminals of transformer 52.

This example in which transformer 52 both receives and outputs differential signals is illustrative and non-limiting. If desired, transformer 52 may form a balun that converts radio-frequency signals between differential signals and single-ended signals. For example, output path 64 may be a single-ended signal path having only signal line 64A coupled to terminal 76 (without signal line 64B). In this implementation, signal line 64B is omitted and terminal 78 of secondary coil Ls is instead coupled to ground 82 (or another reference potential/voltage) over ground (short circuit) path 80. Ground 82 is sometimes also referred to herein as reference potential 82. As such, terminals 76 and 78 may collectively form a single-ended signal (output) port of transformer 52. Transformer 52 may receive radio-frequency signals over terminals 70 and 72 as differential signals, may convert the differential signals into corresponding single-ended signals, and may output the single-ended signals to the output stage over signal line 64A. As another example, input path 62 may be a single-ended signal path, signal line 62B may be omitted, terminal 72 of primary coil Lp may be coupled to ground instead of signal line 62B, output path 64 may be a differential signal path, terminal 78 may be coupled to signal line 64B instead of ground 82, and transformer 52 may convert single-ended signals received over input path 62 into differential signals output over output path 64. Implementations in which transformer 52 receives and outputs differential signals are sometimes described herein for the sake of simplicity.

As shown in FIG. 4, primary coil Lp may have a center tap contact 83 coupled to a first center tap path 56A. Center tap contact 83 is sometimes also referred to herein as center tap conductor 83 or center tap 83 of primary coil Lp. Primary coil Lp may receive center tap signal CTSIG at center tap contact 83 over center tap path 56A. If desired, secondary coil Ls may have a center tap contact 85 coupled to a second center tap path 56B. Secondary coil Lp may receive the same center tap signal CTSIG or another center tap signal at center tap contact 85 over center tap path 56B.

Primary coil Lp may have a first portion 84 that extends from center tap contact 83 to terminal 70. Primary coil Lp may have a second portion 86 that extends from center tap contact 83 to terminal 72. If desired, portions 84 and 86 may be equal or approximately equal in length (e.g., portions 84 and 86 may exhibit equal inductances, center tap 83 may be located on the conductor that forms primary coil Lp halfway between terminals 70 and 72, etc.). Portions 84 and 86 may each include one turn, more than one turn, or less than one turn or winding of the conductor that forms primary coil Lp.

DCA 60 may include a set of N switchable capacitors 90 (e.g., a first switchable capacitor 90-1, an Nth switchable capacitor 90-N, etc.). Each switchable capacitor 90 (sometimes referred to herein as unit cells 90 or capacitor unit cells 90) is coupled to a different respective point (terminal) 96 on primary coil Lp (e.g., in parallel between primary coil Lp and ground 82 or another reference voltage/potential). Each switchable capacitor 90 may include a respective fixed capacitor 94 coupled in series with a respective switch 92 between the corresponding point 96 on primary coil Lp and ground 82. Capacitors 94 may be formed from discrete capacitor components (e.g., surface-mount technology (SMT) capacitors) and/or as distributed capacitors having capacitor electrodes formed from patches, plates, or segments of conductive material patterned onto one or more layers of the substrate of transformer 52. Each capacitor 94 in DCA 60 may have the same capacitance or different capacitors 94 may have different capacitances.

The set of N switchable capacitors 90 in DCA 60 may include a first subset of switchable capacitors 90 (sometimes referred to herein as a first set of one or more switchable capacitors 90) coupled to points 96 on portion 84 of primary coil Lp (e.g., points 96 interposed on primary coil Lp between center tap contact 83 and terminal 70). The set of N switchable capacitors 90 may also include a second subset of switchable capacitors 90 (sometimes referred to herein as a second set of one or more switchable capacitors 90) coupled to points 96 on portion 86 of primary coil Lp (e.g., points 96 interposed on primary coil Lp between center tap contact 83 and terminal 72). The first subset may include the same number of switchable capacitors 90 as the second subset or may include a different number of switchable capacitors 90 than the second subset. Points 96 may be located in the vicinity of (e.g., adjacent to or around) center tap contact 83. For example, 95%, 90%, 85%, 80%, 75%, more than 90%, more than 95%, more than 80%, more than 75%, more than 70%, more than 60%, or more than half (50%) of the length of portion 84 of primary coil Lp may be disposed between DCA 60 (e.g., the point 96 coupled to switchable capacitor 90-1) and terminal 70. Similarly, 95%, 90%, 85%, 80%, 75%, more than 90%, more than 95%, more than 80%, more than 75%, more than 70%, more than 60%, or more than half of the length of portion 86 of primary coil Lp may be disposed between DCA 60 (e.g., the point 96 coupled to switchable capacitor 90-N) and terminal 72. If desired, each point 96 may be coupled to a straight segment of primary coil Lp, the segment of portion 84 of primary coil Lp extending from DCA 60 to terminal 70 may be non-straight (e.g., curved), may include one or more turns or winding of the conductor in primary coil Lp, or may include part of a turn or winding (e.g., greater than zero degrees of winding) of the conductor in primary coil Lp, and the segment of portion 86 of primary coil Lp extending from DCA 60 to terminal 72 may be non-straight (e.g., curved), may include one or more turns or winding of the conductor in primary coil Lp, or may include part of a turn or winding (e.g., greater than zero degrees of winding) of the conductor in primary coil Lp.

Each point 96 is located at a different respective distance X along primary coil Lp from center tap contact 83, where the location of center tap contact 83 is defined as distance X=0. The points 96 on portion 84 of primary coil Lp (e.g., the points 96 coupled to the first subset of switchable capacitors 90) may each be at a different respective distance X>0 from center tap contact 83, whereas the points 96 on portion 84 of primary coil Lp (e.g., the points 96 coupled to the second subset of switchable capacitors 90) may each be at a different respective distance X<0 from center tap contact 83. If desired, the farthest switchable capacitor 90 from center tap contact 83 along portion 84 of primary coil Lp (e.g., switchable capacitor 90-1) may be located at the same distance from center tap contact 83 as the farthest switchable capacitor 90 from center tap contact 83 along portion 86 of primary coil Lp (e.g., switchable capacitor 90-N). Points 96 may be evenly spaced along primary coil Lp or may be unevenly spaced along primary coil Lp.

Switches 92 in DCA 60 may receive control signal(s) CTRL over control path 58. Control signal(s) CTRL control the state of switches 92 to selectively activate a set of one or more switchable capacitors 90 at a given time (e.g., while the remaining switchable capacitors 90 in DCA 60 are inactive). When a switchable capacitor 90 is active (sometimes also referred herein to as the switchable capacitor 90 being turned on, enabled, activated, or coupled/connected between primary coil Lp and ground 82), the switchable capacitor effectively forms a capacitance (e.g., a shunt capacitance) between its corresponding point 96 on primary coil Lp and ground 82. The magnitude of the capacitance is given by the capacitance of the corresponding capacitor 94 in the switchable capacitor 90. On the other hand, when a switchable capacitor 90 is inactive (sometimes also referred to herein as the switchable capacitor 90 being turned off, disabled, deactivated/inactive, or decoupled from primary coil Lp), the switchable capacitor forms an open circuit between its corresponding point 96 and ground 82 (e.g., removing the capacitance due to capacitor 94 from the corresponding point 96 on primary coil Lp).

Control signal(s) CTRL may activate (e.g., enable, turn on, close, couple, or connect) a switchable capacitor 90 by turning on (closing) the switch 92 of the switchable capacitor. Control signal CTRL may deactivate (e.g., disable, turn off, open, decouple, or disconnect) a switchable capacitor 90 by turning off (opening) the switch 92 of the switchable capacitor. When turned on, switch 92 forms a short circuit path (e.g., a short circuit impedance, zero impedance, or impedance less than a threshold impedance) between the corresponding capacitor 94 (and thus the corresponding point 96 on primary coil Lp) and ground 82. When turned off, switch 92 forms an open circuit (e.g., an open circuit impedance, infinite impedance, or impedance greater than the threshold impedance) between the corresponding capacitor 94 (and thus the corresponding point 96 on primary coil Lp) and ground 82.

Switch 92 may be implemented as a single-pole single-throw (SPST) switch or another type of switch or switching circuit. In a simplest example, switch 92 may be implemented using a transistor in the substrate for transformer 52, where the transistor has a first source/drain terminal coupled to ground 82, a second source/drain terminal coupled to the corresponding capacitor 94, and a gate terminal that receives control signal CTRL (e.g., a corresponding bit of a digital control signal or an analog control signal asserted at a selected magnitude). When the switch is turned on, control signal CTRL is asserted at the gate terminal (e.g., provided at a logic high level or at a magnitude exceeding a threshold magnitude), causing the transistor to form an impedance less than a threshold impedance or a transconductance greater than a threshold transconductance between its source/drain terminals, allowing current (e.g., more than a threshold amount of current) to flow between the source/drain terminals. When the switch is turned off, control signal CTRL is de-asserted at the gate terminal (e.g., provided at a logic low level or at a magnitude less than a threshold magnitude), causing the transistor to form an impedance greater than a threshold impedance or a transconductance less than a threshold transconductance between its source/drain terminals, preventing current from flowing between the source/drain terminals. In general, switches 92 may be implemented using any desired switch architecture.

During operation, transformer 52 receives a radio-frequency signal at terminals 70 and 72 from input stage 50 (FIG. 3) via signal lines 62A and 62B. Current from the radio-frequency signal flows across primary coil Lp. Primary coil Lp conveys the radio-frequency signal to secondary coil Ls via near-field electromagnetic coupling 74 between primary coil Lp and secondary coil Ls (e.g., primary coil Lp is magnetically coupled to secondary coil Ls such that the current on primary coil Lp induces corresponding current on secondary coil Ls). The magnetic coupling and/or center tap signal CTSIG may configure transformer 52 to perform impedance matching/transformation and/or voltage conversion on the radio-frequency signal, for example. Transformer 52 then passes the radio-frequency signal to output stage 54 (FIG. 3) via terminals 76 and 78 and signal lines 64A and 64B. In implementations where transformer 52 is a balun, transformer 52 converts the radio-frequency signal between a differential signal and a single-ended signal.

Because center tap contact 83 forms a virtual ground for primary coil Lp, when a given switchable capacitor 90 is turned on, the distance X between that switchable capacitor 90 and center tap contact 83 effectively weights the impact of the capacitance from the switchable capacitor on the operation of transformer 52. Since each switchable capacitor 90 is coupled to primary coil Lp at a different point 96 and thus at a different distance X from center tap contact 83, each switchable capacitor 90 exhibits a different effective weighting on the operation of transformer 52 when turned on. Control circuitry 14 may selectively turn on a set of one or more switchable capacitors 90 that collectively exhibit a weighting that causes DCA 60 to reverse or mitigate the effects of asymmetry in transformer 52. For example, control circuitry 14 may turn on more switchable capacitors 90 at one side of center tap contact 83 (e.g., coupled to points 96 on portion 84 of primary coil Lp) than the other side of center tap contact 83 (e.g., coupled to points 96 on portion 86 of primary coil Lp) to produce an asymmetry in the response of transformer 52 that is equal and opposite to the inherent asymmetry associated with the conductors of primary coil Lp and secondary coil Ls as introduced upon disposing transformer 52 on its substrate (e.g., process variations or asymmetries associated with the design and/or fabrication of transformer 52). In situations where the control circuitry turns on only a single switchable capacitor 90, the particular switchable capacitor that is turned on may be coupled to a point 96 located at a particular distance X away from center tap contact 83 that causes DCA 60 to reverse the asymmetry of transformer 52 while conveying signals.

In this way, DCA 60 (e.g., the active switchable capacitor(s) 90 and the corresponding asymmetric capacitance coupled between primary coil Lp and ground 82 around/adjacent center tap 83) may minimize, mitigate, or suppress the CM-to-DM conversion of undesired signal components such as spurs arising from the local oscillator and its harmonics, second harmonic distortion (HD2) of a power amplifier, or other components by transformer 52. This allows the radio-frequency signal output by transformer 52 to be processed by output stage 54 (FIG. 3) without producing emissions violations or otherwise deteriorating the performance of wireless circuitry 24.

The example of FIG. 4 is illustrative and non-limiting. Additionally or alternatively, one or more of the switchable capacitors in DCA 60 (or an additional DCA) may be coupled between primary coil Lp and ground 82 at or adjacent to terminals 70 and 72 and/or between secondary coil Ls and ground 82 at or adjacent to terminals 76 and 78. Additionally or alternatively, DCA 60 (or an additional DCA) may be coupled to secondary coil Ls at or adjacent to center tap contact 85 (e.g., where switchable capacitors 90 are coupled to respective points 96 at different locations X on secondary inductor Ls around center tap contact 85). In other words, one or both of primary coil Lp and secondary coil Ls may include a DCA such as DCA 60 coupled to the coil(s) about the corresponding center tap contact(s). However, coupling DCA 60 to primary coil Lp around and adjacent to center tap contact 83 of primary coil Lp (as shown in FIG. 4) may configure transformer 52 to exhibit an unaltered DM response (whereas other DCA locations may undesirably alter the DM response of transformer 52) and/or may allow capacitors 94 to be implemented with relatively high capacitance values, thereby making the capacitors easier to fabricate on the substrate of transformer 52. Center tap contact 85 and center tap path 56 of secondary coil Ls may be omitted if desired.

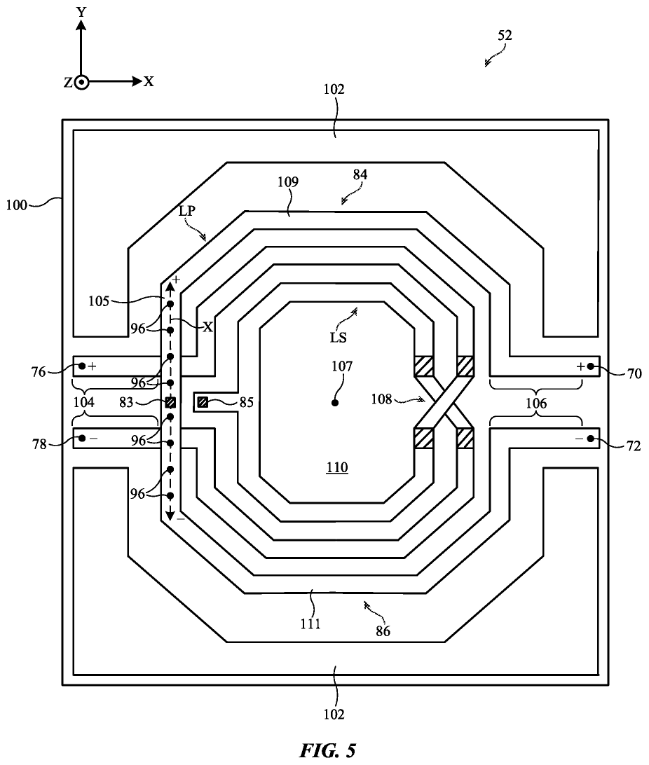

FIG. 4 is a top-down layout diagram showing one example of how transformer 52 may be implemented on a corresponding substrate 100 (e.g., an integrated circuit chip, semiconductor substrate, dielectric substrate, printed circuit substrate, etc.). As shown in FIG. 5, primary coil Lp may be formed from first conductive traces disposed on substrate 100 (e.g., a first layer of substrate 100). The first conductive traces may include a first segment such as central segment 105. Center tap contact 83 may be coupled to central segment 105 (e.g., at the center of the length of segment 105, or distance X=0).

The first conductive traces may include a second segment 109 extending from a first end of central segment 105 to terminal 70. Second segment 109 may form portion 84 of primary coil Lp. The first conductive traces may include a third segment 111 extending from a second end of central segment 105 (opposite the first end of central segment 105) to terminal 72. Third segment 111 may form portion 86 of primary coil Lp.

If desired, central segment 105 may be straight/linear (e.g., extending parallel to the Y-axis) whereas segments 109 and 111 are non-linear (e.g., following a curved, winding, meandering, non-straight, or non-linear path from central segment 105 to terminals 70 and 72 respective). For example, central segment 105, segment 109, and segment 111 of primary coil Lp may collectively wind around a central axis 107 (e.g., parallel to the Z-axis) and may laterally surround a central region 110.

Segment 109 of primary coil Lp may laterally turn, wind, wrap, or rotate around central axis 107 by a first non-zero angle in the X-Y plane (e.g., more than 30 degrees, more than 60 degrees, more than 45 degrees, more than 90 degrees, more than 120 degrees, more than 180 degrees, more than 360 degrees, etc.). Similarly, segment 111 of primary coil Lp may laterally turn, wind, wrap, or rotate around central axis 107 by a second non-zero angle (e.g., more than 30 degrees, more than 60 degrees, more than 45 degrees, more than 90 degrees, more than 120 degrees, more than 180 degrees, more than 360 degrees, etc.) opposite segment 109. In the example of FIG. 5, segment 109 and segment 111 each turn by between 120 and 180 degrees around central axis 107. This is illustrative and non-limiting. If desired, primary coil Lp may include more than one complete turn or winding around central axis 107 (e.g., one and a half turns, two turns, three turns, four turns, etc.). In these implementations, the first conductive traces used to form primary coil Lp may be disposed on multiple stacked layers of substrate 100 and parts of segments 109 and 111 on different layers may be coupled together using conductive vias extending through the layer(s) (e.g., at one or more cross-over points).

The N switchable capacitors 90 in DCA 60 (FIG. 4) may be coupled to different points 96 along central segment 105 between center tap contact 84 and segments 109/111 (e.g., at different distances X from center tap contact 83). Segment 109 may be interposed between central segment 105 (points 96) and terminal 70. Segment 111 may be interposed between central segment 105 (points 96) and terminal 72. In the example of FIG. 5, there are N=8 switchable capacitors 90 in DCA 60 (e.g., a first subset of four switchable capacitors 90 coupled to points 96 on central segment 105 between center tap contact 83 and segment 109 and a second subset of four switchable capacitors 90 coupled to points 96 on central segment 105 between center tap contact 83 and segment 111). In general, N may be any desired integer greater than two (e.g., three, four, five, six, seven, nine, ten, eleven, twelve, more than twelve, sixteen, more than sixteen, thirty-two, sixty-four, more than sixty-four, etc.). Central segment 105 may follow a non-linear path if desired (e.g., may be curved).

Secondary coil Ls may be formed from second conductive traces disposed on substrate 100. The second conductive traces may be confined to a single layer of substrate 100 or may be distributed across multiple layers of substrate 100. Some or all of the second conductive traces may be formed on some or all of the same layers as the first conductive traces used to form primary coil Lp or may, if desired, be formed on different layers from the first conductive traces. The second conductive traces may extend between terminals 76 and 78 and may wind, wrap, turn, or rotate once, more than once, or less than once about central axis 107 or another axis parallel to central axis 107. The second conductive traces may laterally surround a central region of secondary coil Ls. The second conductive traces in secondary coil Ls may at least partially overlap the first conductive traces in primary coil Lp and/or the central region of secondary coil Ls may at least partially overlap the central region of primary coil Lp. If desired, center tap contact 85 may be coupled to the second conductive traces halfway along the length of secondary coil Ls between terminals 76 and 78.

In the implementation shown in FIG. 5, for example, the second conductive traces in secondary coil Ls wind, wrap, turn, or rotate twice (e.g., 720 degrees) around central axis 107 (e.g., the second conductive traces are distributed across at least two layers of substrate 100 and include crossover point 108), the turns of the second conductive traces laterally surround central region 110, and all of the turns of the second conductive traces are laterally surrounded by the first conductive traces in primary coil Lp. This is illustrative and non-limiting. In general, primary coil Lp and secondary coil Ls may have other layouts on substrate 100. Secondary coil Ls may laterally surround some or all of primary coil Lp if desired. Distributing the conductive traces of primary coil Lp and/or secondary coil Ls across multiple layers in substrate 100 may, for example, serve to extend the overall length of the coil(s) while minimizing the lateral footprint of transformer 52, thereby allowing transformer 52 to consume a minimal amount of space/area on substrate 100.

A ring of conductive ground traces such as ground traces 102 may be patterned onto substrate 100. Ground traces 102 may laterally surround primary coil Lp and secondary coil Ls and may have any desired shape. Ground traces 102 may be laterally separated from the outer edges of primary coil Lp and/or secondary coil Ls by a non-zero distance. If desired, ground traces 102 may be patterned on two or more layers of substrate 100. In these examples, conductive vias may couple the ground traces on each of the layers together. Ground traces 102 may be held at a reference potential and may help to electromagnetically shield inductor from other components. Ground traces 102 therefore may sometimes be referred to herein as shielding traces 102. In implementations where transformer 52 has a single-ended output (e.g., where terminal 78 is coupled to ground 82 over ground path 80 instead of signal path 64B of FIG. 4), second terminal 78 may be coupled to ground traces 102.

If desired, DCA 60 (FIG. 4) or an additional DCA may be coupled to primary coil Lp adjacent to or around terminals 70 and 72 (e.g., along segments 106 of primary coil Lp) and/or may be coupled to secondary coil Ls adjacent to or around terminals 76 and 78 (e.g., along segments 104 of secondary coil Ls). However, coupling DCA 60 (FIG. 4) to central segment 105 around center tap contact 83 of primary inductor Lp may optimize the DM performance of transformer 52 and may allow capacitors 94 (FIG. 4) to be implemented with relatively high capacitances (e.g., 66 fF-140 fF or higher), thereby facilitating the fabrication of capacitors 94 on substrate 100.

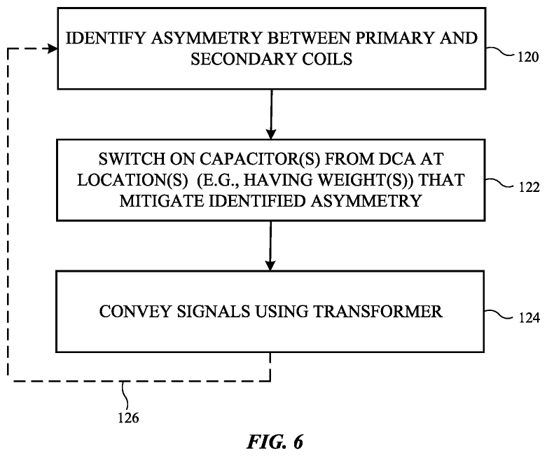

FIG. 6 is a flow chart of operations involved in using transformer 52 to convey radio-frequency signals. The particular set of switchable capacitors 90 in DCA 60 (FIG. 4) that are used to mitigate asymmetry in transformer 52 may be identified and activated prior to operation of device 10 by an end user and/or during operation of device 10 by an end user.

At operation 120, an asymmetry between primary coil Lp and secondary coil Ls may be identified. When activating switchable capacitors 90 prior to operation of device 10 by an end user, control circuitry in design, manufacturing, fabrication, assembly, validation, and/or test equipment may identify the asymmetry (e.g., based on test data gathered using transformer 52, simulation or design data associated with transformer 52, etc.). When activating switchable capacitors 90 during operation of device 10 by an end user, control circuitry 14 may identify the asymmetry. If desired, control circuitry 14 on device 10 (FIG. 1) may gather wireless performance metric data characterizing the radio-frequency performance of transformer 52 (e.g., signal measurements such as emissions measurements) and may identify the asymmetry based on the wireless performance metric data.

At operation 122, control circuitry 14 on device 10 may activate a set of one or more switchable capacitors 90 coupled to primary coil Lp at different location(s) X from center tap contact 83 that, when activated, serve to reverse, minimize, or otherwise mitigate the identified asymmetry. Control circuitry 14 may activate the set of switchable capacitors by providing control signals CTRL to the switches 92 of the switchable capacitors 90 in DCA 60 (e.g., closing the switches 92 of the set of one or more switchable capacitors 90 while keeping the other switches 92 in DCA 60 open).

At operation 124, transformer 52 may convey radio-frequency signals between input stage 50 and output stage 54 (FIG. 3) while the set of one or more switchable capacitors 90 is active. The active switchable capacitors produce asymmetric capacitive weighting (e.g., given by the capacitance(s) of the active switchable capacitor(s) and the distance(s) X of the active switchable capacitor(s) from center tap contact 83) in the response of transformer 52 while conveying the radio-frequency signals in a manner that mitigates the effects of the identified asymmetry of transformer 52. In implementations where the asymmetry is identified and the set of switchable capacitors is activated prior to use of device 10 by an end user, processing may end. The many switchable capacitors 90 of DCA 60 may allow each device being manufactured to be individually provided with an appropriate set of active switchable capacitors 90 that mitigate the particular asymmetry of the transformer 52 in that device (e.g., to mitigate device-to-device process variations across a batch of multiple devices). In implementations where the asymmetry is identified and the set of switchable capacitors is activated during end use of deice 10 by an end user, processing may loop back to operation 120 via path 126 and control circuitry 14 may continue to adjust DCA 60 to ensure that transformer 52 continues to exhibit optimal performance over the operating life of device 10 (e.g., as device 10 is subject to different thermal or environmental conditions, as the components in device 10 age, etc.).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

The foregoing is illustrative and various modifications can be made to the described embodiments. The foregoing embodiments may be implemented individually or in any combination.

What is claimed is:

1. A transformer comprising:
a first coil extending from a first terminal to a second terminal, the first coil having a center tap;
a second coil extending from a third terminal to a fourth terminal, the second coil being magnetically coupled to the first coil; and
a first capacitor coupled between a reference potential and a first point on the first coil, the first point being between the center tap and the first terminal.

2. The transformer of claim 1, further comprising:
a second capacitor coupled between the reference potential and a second point on the first coil, the second point being between the center tap and the second terminal.

3. The transformer of claim 2, further comprising:
a third capacitor coupled between the reference potential and a third point on the first coil, the third point being between the first point and the first terminal.

4. The transformer of claim 1, further comprising:
a second capacitor coupled between the reference potential and a second point on the first coil, the second point being between the first point and the first terminal.

5. The transformer of claim 1, wherein the first terminal is coupled to a first signal line of an input path, the second terminal is coupled to a second signal line of the input path, and the first signal line and the second signal line form a differential pair of signal lines.

6. The transformer of claim 5, wherein the third terminal is coupled to a third signal line of an output path, the fourth terminal is coupled to a fourth signal line of the output path, and the third signal line and the fourth signal line form an additional differential pair of signal lines.

7. The transformer of claim 5, wherein the third terminal is coupled to a third signal line of a single-ended output path and the fourth terminal is coupled to the reference potential.

8. The transformer of claim 1, wherein the primary coil comprises first conductive traces on a substrate and the secondary coil comprises second conductive traces on the substrate.

9. The transformer of claim 8, wherein the first conductive traces comprise a first segment, a second segment extending from a first end of the first segment to the first terminal, and a third segment extending from a second end of the first segment to the second terminal, the center tap and the point being coupled to the first segment.

10. The transformer of claim 9, wherein the second segment winds around a central axis of the first coil by a first non-zero angle and the third segment winds around the central axis by a second non-zero angle.

11. The transformer of claim 10, wherein the first segment is linear, the first non-zero angle is at least 90 degrees, and the second non-zero angle is at least 90 degrees.

12. The transformer of claim 11, further comprising:
a second capacitor coupled between the reference potential and a second point on the first segment, the second point being between the first point and the first terminal;
a third capacitor coupled between the reference potential and a third point on the first segment, the third point being between the second point and the first terminal;
a fourth capacitor coupled between the reference potential and a fourth point on the first segment, the fourth point being between the center tap and the second terminal; and
a fifth capacitor coupled between the reference potential and a fifth point on the first segment, the fifth point being between the fourth point and the second terminal.

13. The transformer of claim 1, further comprising a switch coupled in series with the first capacitor between the first point and the reference potential.

14. A radio-frequency transceiver comprising:
an input stage;
an output stage; and
a transformer coupled between the input stage and the output stage, wherein the transformer includes
a first coil coupled to the input stage and having a center tap,
a second coil coupled to the output stage, the second coil being magnetically coupled to the first coil, and
a capacitor array coupled to the first coil around the center tap.

15. The radio-frequency transceiver of claim 14, wherein the first coil extends from a first terminal to a second terminal, the first terminal and the second terminal are coupled to the input stage, and the capacitor array comprises:
a first set of switchable capacitors coupled in parallel between a first set of points on the first coil and a reference potential, the first set of points being between the center tap and the first terminal; and
a second set of switchable capacitors coupled in parallel between a second set of points on the first coil and the reference potential, the second set of points being between the center tap and the second terminal.

16. The radio-frequency transceiver of claim 15, wherein the first coil has a length from the first terminal to the second terminal, the first set of points being separated from the first terminal by more than half the length of the first coil, and the second set of points being separated from the second terminal by more than half the length of the first coil.

17. The radio-frequency transceiver of claim 15, wherein a first segment of the first coil extends between the first set of points and the first terminal, a second segment of the first coil extends between the second set of points and the second terminal, the first segment turns at least 90 degrees about a central axis of the first coil, and the second segment turns at least 90 degrees about the central axis opposite the first segment.

18. The radio-frequency transceiver of claim 14, wherein the input stage comprises mixer circuitry, the output stage comprises an amplifier, and the center tap is configured to receive a voltage.

19. An electronic device comprising:
a substrate;
an input path having a first signal line on the substrate and a second signal line on the substrate;
an output path having a third signal line on the substrate;
a transformer on the substrate, wherein the transformer includes
a first coil having a first terminal coupled to the first signal line, a second terminal coupled to the second signal line, and a center tap contact, and
a second coil having a third terminal coupled to the third signal line; and
a set of capacitors coupled in parallel between a set of points on the first coil and a reference potential, the set of points being between the center tap contact and the first terminal.

20. The electronic device of claim 19, further comprising:
a set of switches, each switch in the set of switches being coupled in series with a respective capacitor from the set of capacitors between the reference potential and a respective point from the set of points, wherein at least one of the switches in the set of switches is closed and at least one of the switches in the set of switches is open.
